(19) United States
(12) Patent Application Publication
(10) Pub. No.: US 2013/0338815 A1
(43) Pub. Date: Dec. 19, 2013

(54) NUMERICAL CONTROLLER FOR DISPLAYING VIRTUAL CONTROL PANEL

(71) Applicant: FANUC CORPORATION, Yamanashi (JP)

(72) Inventors: Yoshitsugu OGAWA, Yamanashi (JP); Susumu MAEKAWA, Yamanashi (JP)

(73) Assignee: FANUC Corporation, Yamanashi (JP)

(21) Appl. No.: 13/865,262

(22) Filed: Apr. 18, 2013

(30) Foreign Application Priority Data
Jun. 15, 2012 (JP) 2012-135709

(51) Int. Cl. G05B 19/18

(52) U.S. Cl. CPC G05B 19/18
USPC 700/180

(57) ABSTRACT

A numerical controller for controlling a machine tool includes a display which displays a virtual control panel composed of an operation key for operating a machine and a lamp indicating operating information of a machine. A plurality of components (buttons and lamps) of each virtual control panel are defined. Each virtual control panel composed of the defined components is associated with a command code to be given by an NC program, and whether to display or hide the virtual control panel is set. When an NC program is executed, and a command code is read, a virtual control panel corresponding to the command code is displayed or hidden.

### BACKGROUND OF THE INVENTION

1. Field of the Invention

The present invention relates to a numerical controller which displays a virtual control panel for operating an external device and displaying the status of the external device.

2. Description of the Related Art

When external devices are connected to a numerical controller and are used, a control panel having buttons and lamps may be added to operate the external devices and display the statuses of the external devices. In this case, a user needs to bear the cost of adding the control panel, in addition to the cost of purchasing the external devices. It is thus conceivable to display a virtual control panel on a display of the numerical controller and operate the virtual control panel using a key input device or a touch panel, instead of adding pieces of hardware such as a button and a lamp. The virtual control panel eliminates the need for the cost of adding a control panel and allows easier addition and change of buttons and lamps which are components of the virtual control panel.

Japanese Patent Application Laid-Open No. 9-292942 discloses a virtual control panel which is enabled to operate an external device and display the status of the external device on a screen by setting the color, name, displayed character color, signal address to be assigned, and the like of each button or lamp to be displayed on the screen. Japanese Patent Application Laid-Open No. 5-250025 discloses a control panel which allows the arrangement, size, shape, and the like of a switch to be changed.

A virtual control panel suffers from the problem of reduced workability when many buttons and lamps are handled. For example, an external device to be operated and a status signal to be checked may vary among different workpieces to be machined and different work processes even in one machine tool. For this reason, there is a need to efficiently and accurately operate and check a signal among many signals.

An increase in the number of buttons and lamps to be displayed on a virtual control panel increases the display space of the virtual control panel, which leads to an inability to operate and check the virtual control panel while checking a different screen. It is thus conceivable to display a virtual control panel in a region of a screen and use one among a plurality of virtual control panels.

Japanese Patent Application Laid-Open No. 9-292942 described above makes no mention of a plurality of virtual control panels. In contrast, Japanese Patent Application Laid-Open No. 5-250025 discloses handling of a plurality of virtual control panels. The technique disclosed in Japanese Patent Application Laid-Open No. 5-250025, however, requires an operator to perform the operation of selecting a desired virtual control panel from among a plurality of virtual control panels stored to display the virtual control panel. If many buttons and lamps are handled, the operation of changing a virtual control panel is performed with high frequency to display a desired button or lamp among the buttons and lamps. This reduces workability.

### SUMMARY OF THE INVENTION

Under the circumstances, the present invention has an object to provide a numerical controller for displaying a virtual control panel which can automatically display, at a part of a screen, a virtual control panel having necessary buttons and lamps among a plurality of virtual control panels, depending on the situation.

According to a first aspect of the present invention, a numerical controller for displaying a virtual control panel includes a display which displays a virtual control panel composed of an operation key for operating a machine and a lamp indicating operating information of a machine, a virtual control panel definition information storage section in which a plurality of components of each of a plurality of the virtual control panels are defined and stored, a virtual control panel association section which sets association of a command code to be given by an NC program with each of the virtual control panels that is composed of the defined components and whether to display or hide the virtual control panel, and a virtual control panel display execution section which, when the NC program is executed, and one of the command codes set in the virtual control panel association section is read, displays or hides one of the virtual control panels that corresponds to the command code.

The numerical controller may further include a virtual control panel display attribute setting section which sets a command code to be given by the NC program for changing display attributes including size and display position of each of the virtual control panels and a virtual control panel attribute changing section which changes, when the NC program is executed and one of the command codes for changing display attributes is read, the size and display position of one of the virtual control panels that corresponds to the command code.

The numerical controller can further include a definition information input/output section which inputs and outputs virtual control panel definition information stored in the virtual control panel definition information storage section.

According to a second aspect of the present invention, a numerical controller for displaying a virtual control panel includes a display which displays a virtual control panel composed of an operation key for operating a machine and a lamp indicating operating information of a machine, a virtual control panel definition information storage section in which a plurality of components of each of a plurality of the virtual control panels are defined and stored, a virtual control panel association section which sets association of a signal address to be used in a sequence program with each of the virtual control panels that is composed of the defined components and whether to display or hide the virtual control panel, and a virtual control panel display execution section which, when the sequence program is executed, and one of the signal addresses set in the virtual control panel association section is output, displays or hides one of the virtual control panels that corresponds to the signal address.

The numerical controller may further include a virtual control panel display attribute setting section which sets a signal address to be used in the sequence program for changing display attributes including size and display position of each of the virtual control panels and a virtual control panel attribute changing section which changes, when the sequence program is executed and one of the signal addresses for changing display attributes is output, the size and display position of one of the virtual control panels that corresponds to the signal address.

The numerical controller may further include a definition information input/output section which inputs and outputs virtual control panel definition information stored in the virtual control panel definition information storage section.

According to the present invention, there can be provided a numerical controller for displaying a virtual control panel which automatically displays, at a part of a screen, one having necessary buttons and lamps suited to the situation among a plurality of virtual control panels.

### BRIEF DESCRIPTION OF THE DRAWINGS

The foregoing and other objects and features of the present invention will become more apparent from the following description of an embodiment thereof, taken in conjunction with the accompanying drawings, in which:

FIG. 1 is a schematic configuration diagram for explaining a numerical controller which controls a machine tool;

FIG. 2 is a view for explaining soft keys which are provided at an end of a display screen of a display device of the numerical controller in FIG. 1;

FIG. 3 is a view for explaining an interface screen (a list of setup screens) for creating a virtual control panel which is displayed on the display screen;

FIG. 4 is a view for explaining an example of an entry screen displayed on the display screen of the display device when “Display of button/lamp setup screen” is selected from the virtual control panel creation screen shown in FIG. 3;

FIG. 5 is a view for explaining an example of an entry screen displayed on the display screen of the display device when “First example of virtual control panel setup screen” is selected from the virtual control panel creation screen shown in FIG. 3;

FIG. 6 is a view for explaining an example of an entry screen displayed on the display screen of the display device when “Second example of virtual control panel setup screen” is selected from the virtual control panel creation screen shown in FIG. 3;

FIGS. 7A to 7D are each a view for explaining an example in which a corresponding one of virtual control panels whose display sizes and display positions are set as shown in FIG. 6 is displayed on the display screen of the display device;

FIG. 8 is a view for explaining an example of an entry screen displayed on the display screen of the display device when “Third example of virtual control panel setup screen” is selected from the virtual control panel creation screen shown in FIG. 3;

FIG. 9 is a chart for explaining the flow of a button display process;

FIG. 10 is a chart for explaining the flow of a lamp display process;

FIG. 11A is a view for explaining non-display and display of a virtual control panel according to an M-code command, and FIG. 11B is a view for explaining non-display and display of a virtual control panel according to a sequence program;

FIG. 12 is a view showing an example of an arbitrary screen for explaining non-display and display of a virtual control panel according to the M-code command (FIG. 11A) or non-display and display of a virtual control panel according to the sequence program (FIG. 11B); and

FIG. 13 is a chart for explaining the flow of a process to be executed by a virtual control panel display execution section.

### DETAILED DESCRIPTION OF THE PREFERRED EMBODIMENT

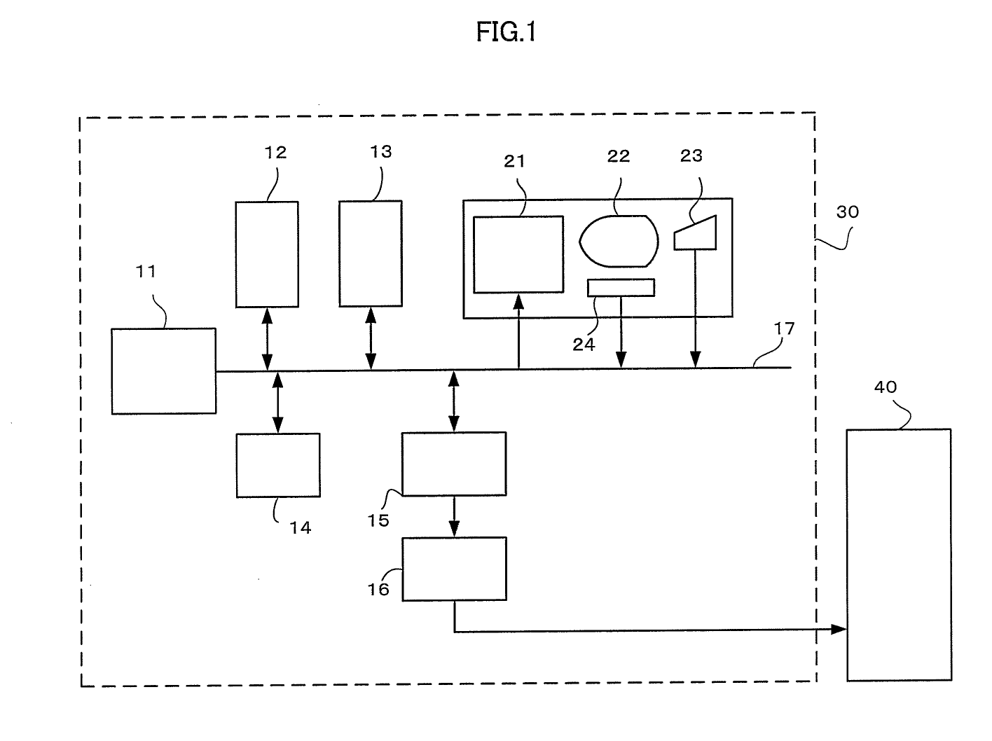

The schematic configuration of a numerical controller which controls a machine tool will be described with reference to FIG. 1.

A processor 11 of a numerical controller 30 controls the whole of the numerical controller 30 in accordance with a system program stored in a ROM 12. The ROM 12 stores a program for implementing the function of operating an external device and displaying the status of the external device in the numerical controller 30. The ROM 12 also stores a program for implementing the function of displaying a virtual control panel according to the present invention, and the program performs (a) setting buttons and lamps which are components to be displayed on a screen, (b) setting a plurality of virtual control panels using the buttons and lamps that are set components, and (c) automatically displaying, at a part of the screen, one having necessary buttons and lamps suited to the situation among the plurality of set virtual control panels.

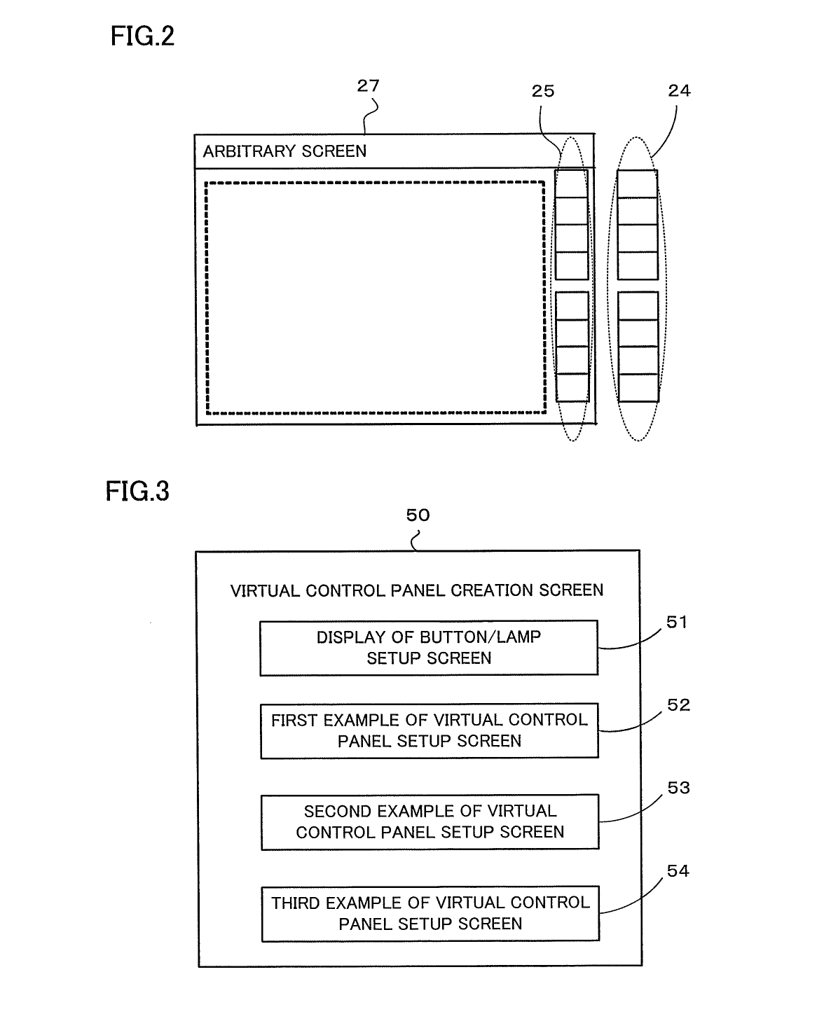

A plurality of soft keys 25 are displayed at a fixed position at an end of a display screen 27 (FIG. 2) of a display device 22. The soft keys 25 are buttons on the screen, to which various functions can be assigned, and each soft key 25 can be turned on or off by pressing a corresponding one of buttons 24 as pieces of hardware which are arranged near the soft keys 25. Note that if a touch panel is attached to the display device 22, each soft key 25 can be turned on or off by pressing a corresponding button on the screen. Note that if the numerical controller 30 includes neither a touch panel nor the buttons 24, the soft keys 25 can be turned on or off using a keyboard 23.

An axis control circuit 15 receives an axis movement command from the processor 11 and outputs the axis command to a servo-amplifier 16. The servo-amplifier 16 receives the axis command and drives a servomotor which is provided in a machine tool 40.

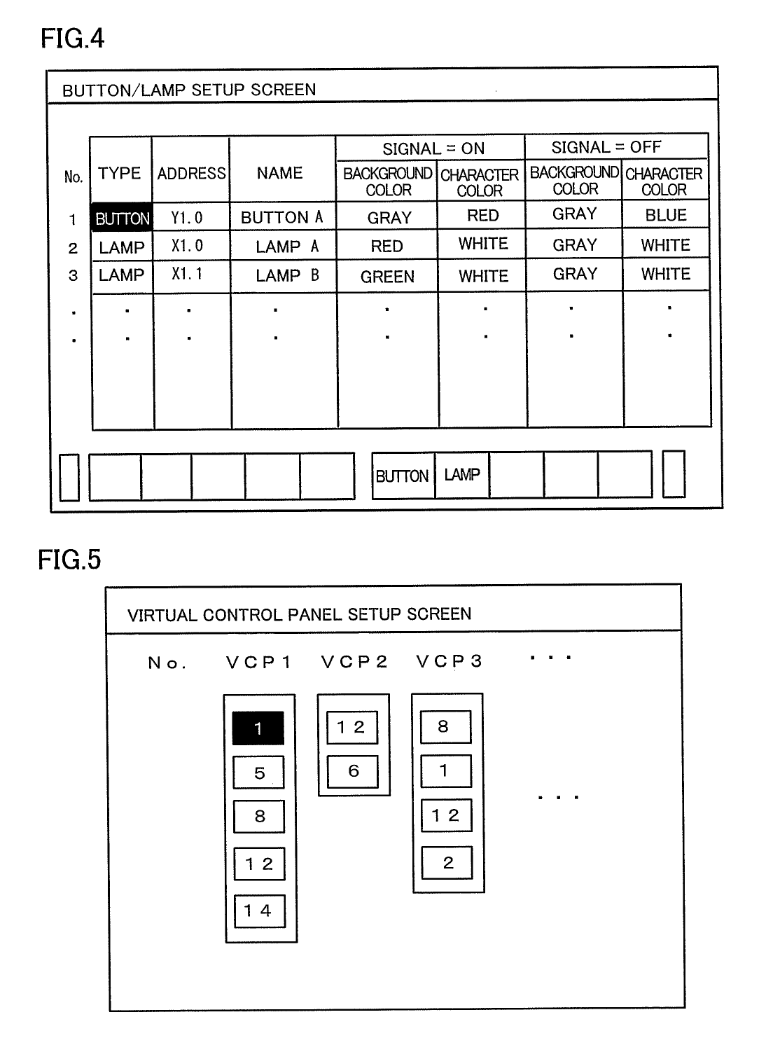

An SRAM or the like is used as a RAM 13, and various types of data are stored in the RAM 13. A nonvolatile memory 14 stores an interface screen (see FIG. 3) for giving instructions to create a virtual control panel, button/lamp setup information (see FIG. 4), and virtual control panel setup screen information (see FIGS. 5, 6, and 8), which are to be described later. A display control circuit 21 converts a digital signal to a signal for display and passes the signal to the display device 22. A liquid crystal display or the like is used as the display device 22. The keyboard 23 is manual input means for inputting machining data, graphic data, and the like.

The process of (1) creating virtual control panels, (2) displaying a virtual control panel on the display device and operating the virtual control panel, (3) displaying a virtual control panel suited to the situation, and (4) inputting and outputting setup data for a virtual control panel, using the pieces of hardware of the numerical controller 30 described above will be described below.

### (1) Creation of Virtual Control Panel

### <Setting of Components of Virtual Control Panel>

Data on a component such as a button or a lamp of a virtual control panel is first stored in the nonvolatile memory 14 of the numerical controller 30. The data stored in the nonvolatile memory 14 is referred to as “button/lamp attribute data.” A case where buttons and lamps are set as components of a virtual control panel will be taken as an example in the following description.

An operator can give instructions to execute a virtual control panel creation program stored in the ROM 12 of the numerical controller 30, using input means (the keyboard 23, button 24, or soft keys 25) of the numerical controller 30. When the virtual control panel creation program starts being executed, a list of setup screens (a virtual control panel creation screen 50) shown in FIG. 3 is displayed as an interface screen on the display screen 27 of the display device 22. In the virtual control panel creation screen 50 that is an interface screen, selective screens of “Display of button/lamp setup screen” (51), “First example of virtual control panel setup screen” (52), “Second example of virtual control panel setup screen” (53) and “Third example of virtual control panel setup screen” (54) are respectively displayed.

If the operator selects “Display of button/lamp setup screen” (51) from the virtual control panel creation screen 50 shown in FIG. 3, the screen shown in FIG. 4 is displayed on the display screen of the display device 22 (see FIG. 1). FIG. 4 is a view for explaining an example of a button/lamp setup screen to be displayed on the screen. The color, name, character color, signal address to be assigned, and the like of each button or lamp to be displayed in each virtual control panel are set according to the specifications of the button or lamp by using the screen in FIG. 4. A signal address here refers to a memory address where data, based on which the on/off status of a button or a lamp is switched, is stored.

At the same time as the setting of the buttons and lamps, respective ID numbers are assigned to the buttons and lamps. In the example in FIG. 4, numbers (1, 2, 3, . . . ) are assigned as ID numbers to the buttons and lamps.

For ID number 1 of button/lamp, the type is set to “button”, the signal address is set to “Y1.0”, the name is set to “button A”, the background color and character color when the signal is on are set to “gray” and “red”, respectively, and the background color and character color when the signal is off are set to “gray” and “blue”, respectively.

For ID number 2 of button/lamp, the type is set to “lamp”, the signal address is set to “X1.0”, the name is set to “lamp A”, the background color and character color when the signal is on are set to “red” and “white”, respectively, and the background color and character color when the signal is off are set to “gray” and “white”, respectively.

For ID number 3 of button/lamp, the type is set to “lamp”, the signal address is set to “X1.1”, the name is set to “lamp B”, the background color and character color when the signal is on are set to “green” and “white”, respectively, and the background color and character color when the signal is off are set to “gray” and “white”, respectively.

As described above, if the buttons and lamps are set, as shown in FIG. 4, set pieces of data are stored, for example, as pieces of “button/lamp attribute data” in the nonvolatile memory 14.

### <Setting of Virtual Control Panel Screen>

After pieces of data on components such as buttons and lamps of virtual control panels are set, data for setting which ones of the buttons and lamps to arrange in each virtual control panel to be displayed on the display device 22 is stored as a piece of “virtual control panel first attribute data” in the nonvolatile memory 14 of the numerical controller 30.

When the operator selects “First example of virtual control panel setup screen” (52) from the virtual control panel creation screen 50 shown in FIG. 3, the entry screen shown in FIG. 5 is displayed on the display screen 27 of the display device 22. By using the entry screen in FIG. 5, a plurality of virtual control panels can be created and stored. As shown in FIG. 5, the respective ID labels VCP1, VCP2, VCP3, . . . are assigned to created virtual control panels. The virtual control panel VCP1 uses buttons or lamps which are set to have button/lamp ID numbers of 1, 5, 8, 12, and 14. The virtual control panel VCP2 uses buttons or lamps which are set to have button/lamp ID numbers of 12 and 6. The virtual control panel VCP3 uses buttons or lamps which are set to have button/lamp ID numbers of 8, 1, 12, and 2.

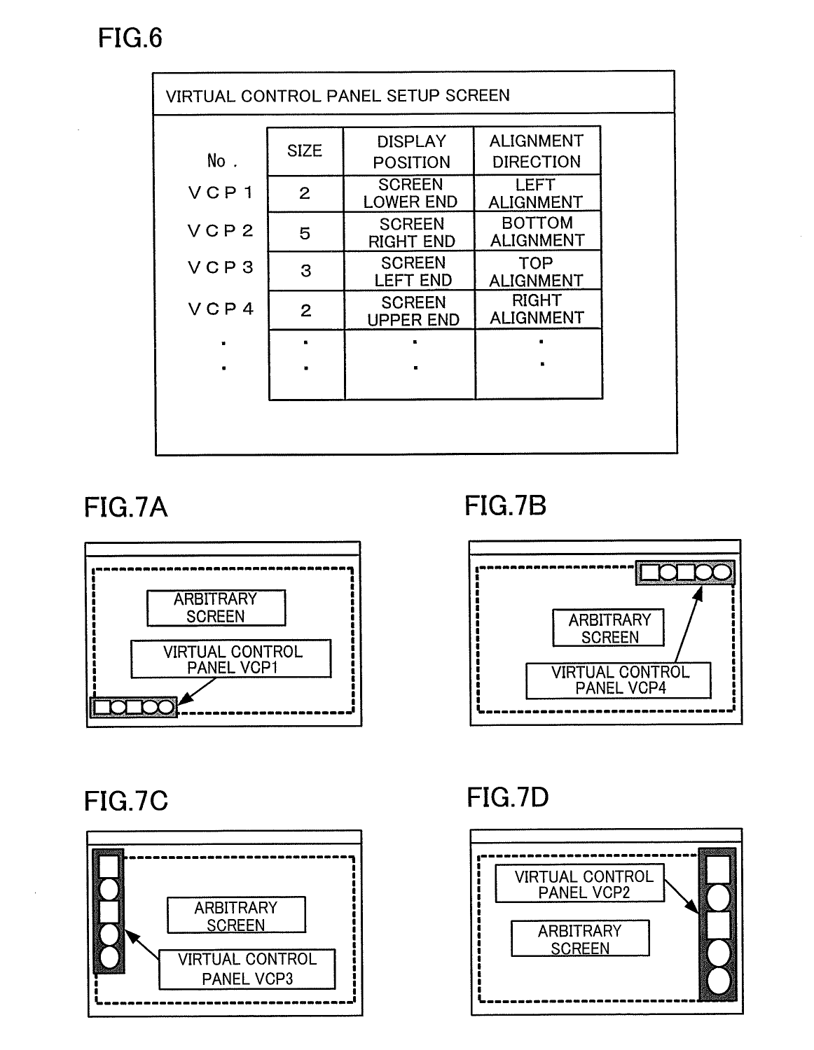

When the operator selects “Second example of virtual control panel setup screen” (53) from the virtual control panel creation screen 50 shown in FIG. 3, the entry screen shown in FIG. 6 is displayed on the display screen 27 of the display device 22.

After buttons and lamps are set in the virtual control panels VCP1, VCP2, VCP3, . . . , as shown in FIG. 5, a screen for setting the display size, display position, and alignment direction of each of the virtual control panels VCP1, VCP2, VCP3, . . . set using the screen in FIG. 5 is displayed on the display screen 27 of the display device 22, as shown in FIG. 6. The size, position, and alignment direction of each virtual control panel to be displayed are set by using the screen in FIG. 6. As shown in FIG. 6, the size and initial display position can be set for each of the virtual control panels VCP1, VCP2, VCP3, . . . set using the screen in FIG. 5, as needed. The size of each virtual control panel can be set in, e.g., 5 levels (1 to 5). The initial display position of each virtual control panel is set using one of an upper end, a lower end, a left end, and a right end of the display screen 27 of the display device 22 and an alignment direction (top alignment, bottom alignment, left alignment, and right alignment). Set pieces of data are stored as a piece of “virtual control panel second attribute data” in the nonvolatile memory 14.

In the setup example shown in FIG. 6, the virtual control panel VCP1 is set to have the size of 2 and be displayed left-aligned (close to the left) at the lower end of the display screen; the virtual control panel VCP2 is set to have the size of 5 and be displayed bottom-aligned (close to the bottom) at the right end of the display screen; the virtual control panel VCP3 is set to have the size of 3 and be displayed top-aligned (close to the top) at the left end of the display screen; and the virtual control panel VCP4 is set to have the size of 2 and be displayed right-aligned (close to the right) at the upper end of the display screen.

Examples in which a corresponding one of the virtual control panels VCP1, VCP2, VCP3, and VCP4 whose display sizes and initial display positions are set as shown in FIG. 6 is displayed on the display screen 27 of the display device 22 will be described with reference to FIGS. 7A to 7D. The virtual control panels are each displayed so as to be superimposed on a part (a lower end, an upper end, a left end, and a right end of the screen) of an already displayed screen, as shown in FIGS. 7A to 7D.

FIG. 7A shows an example in which the virtual control panel VCP1 is displayed left-aligned at the lower end of the display screen 27 of the display device 22, in the size of 2. FIG. 7B shows an example in which the virtual control panel VCP4 is displayed right-aligned at the upper end of the display screen 27 of the display device 22, in the size of 2. FIG. 7C shows an example in which the virtual control panel VCP3 is displayed top-aligned at the left end of the display screen 27 of the display device 22, in the size of 3. FIG. 7D shows an example in which the virtual control panel VCP2 is displayed bottom-aligned at the right end of the display screen 27 of the display device 22, in the size of 5.

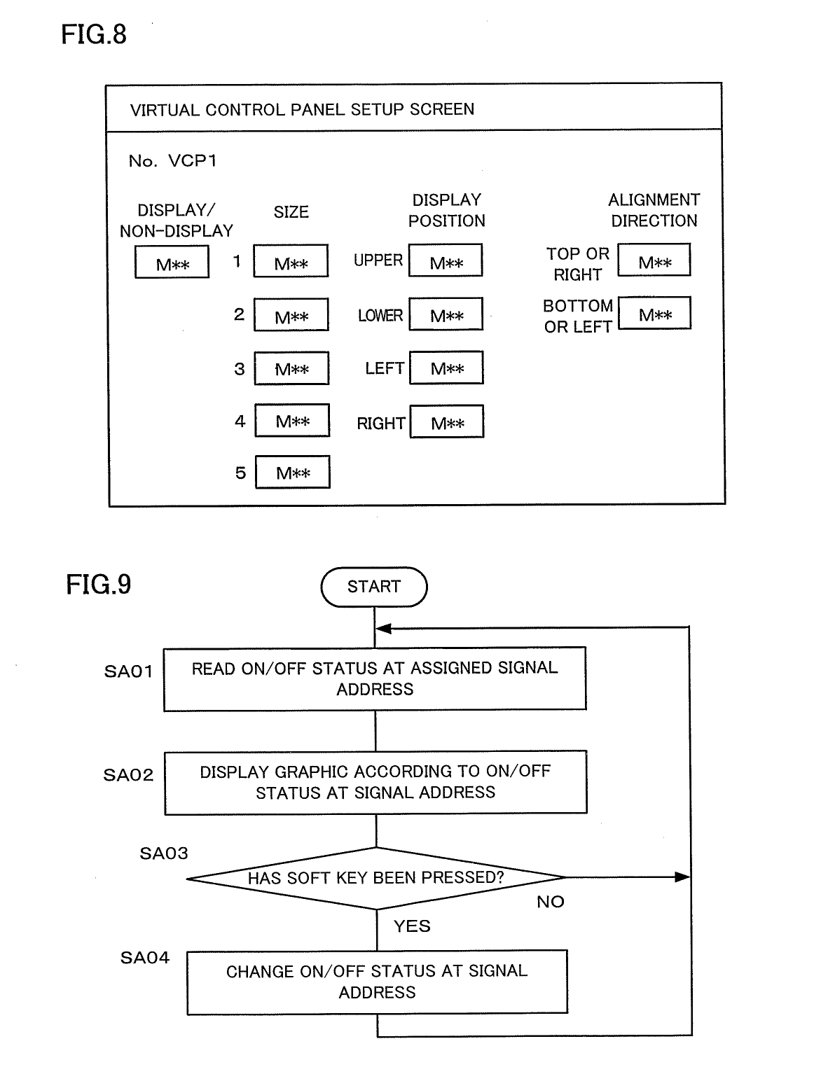

When the operator selects “Third example of virtual control panel setup screen” (54) from the virtual control panel creation screen 50 shown in FIG. 3, the entry screen shown in FIG. 8 is displayed on the display screen 27 of the display device 22.

The operator can set M-codes for changing the size, on-screen display position, and alignment direction of each virtual control panel already set (initialized) on the setup screen shown in FIG. 6, by using the screen in FIG. 8. Each virtual control panel can be switched between display and non-display by specifying an M-code associated with the virtual control panel in a machining program. Note that the screen can be changed to a screen for setting a signal address at which data is turned on by a sequence program by configuring the screen such that an address is entered in an entry field instead of an M-code.

The association of each virtual control panel with M-codes (or signals) can be set from the setup screen as shown in FIG. 8. FIG. 8 shows an example of a virtual control panel setup screen for associating M-codes with the virtual control panel VCP1. In this example, the virtual control panel VCP1 is switched between display and non-display. An input device such as the keyboard 23 of the numerical controller 30 is used to select the virtual control panel VCP1 from among the plurality of virtual control panels VCP1, VCP2, VCP3, . . . set using the screen in FIG. 5. On the screen in FIG. 8, M-codes (or signal addresses) for changing the size, on-screen display position, and alignment direction of the virtual control panel that are already set (initialized) can be set. By giving an M-code set on the screen in FIG. 8 in a machining program or turning on data on a signal address set on the screen in a sequence program, the size, display position, and alignment direction of the selected virtual control panel can be changed. Note that pieces of data on M-codes or signal addresses specified on the screen shown in FIG. 8 are stored in the nonvolatile memory 14.

### (2) Display of Virtual Control Panel on Display Device and Operation

When the creation of the virtual control panels ends, the operator switches the display mode of the display device 22 of the numerical controller 30 from virtual control panel creation mode to normal display mode. A virtual control panels is displayed on the display screen 27 of the display device 22 on the basis of pieces of data (FIGS. 4, 5, and 6) on the color, name, displayed character color, type, size, display position, and alignment direction of each button or lamp set in the numerical controller 30. For example, if an ID number of 1 of the virtual control panels is set for a default screen, a corresponding virtual control panel (with the ID number of 1) is displayed on the display screen 27 of the display device 22. When the on/off status of an assigned signal changes, the display status of a button or a lamp corresponding to the signal of the virtual control panel changes in response to the change.

FIG. 9 is a chart for explaining the flow of a button display process. The flow will be described below along with steps.

[Step SA01] The on/off status at each assigned signal address is read.
[Step SA02] A graphic is displayed according to the on/off status at each signal address.
[Step SA03] It is determined whether any soft key has been pressed or not. If any soft key has been pressed (YES), the processing proceeds to step SA04. On the other hand, if no soft key has been pressed (NO), the processing returns to step SA01 to continue the process.
[Step SA04] The on/off status at a corresponding signal address is changed. The processing returns to step SA01 to continue the process.

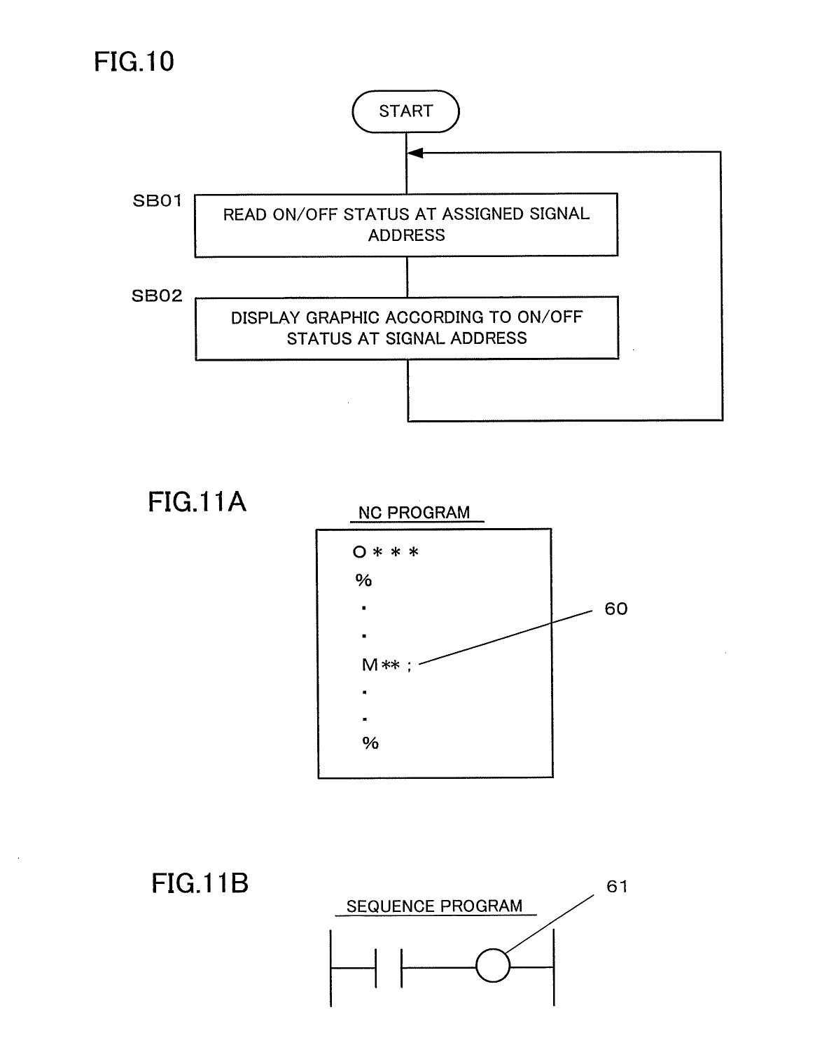

FIG. 10 is a chart for explaining the flow of a lamp display process. The flow will be described below along with steps.

[Step SB01] The on/off status at each assigned signal address is read.
[Step SB02] A graphic is displayed according to the on/off status at each signal address. The processing returns to step SB01.

Such a virtual control panel is displayed so as to be superimposed on a part of an already displayed screen (see FIGS. 7A to 7D). Since a user can set the display position and size of a virtual control panel, the virtual control panel can be displayed at an operationally convenient part.

Generally, many of the display devices 22 in controllers of machine tools each include soft keys 25, as shown in FIG. 2. The soft keys 25 are always displayed at fixed positions of the display screen 27 of the display device 22. In this case, a virtual control panel may be switched between display and non-display by operation at a fixed position of the display screen 27 where the soft keys 25 are displayed, like operation on the soft keys 25.

### (3) Display of Virtual Control Panel Suited to Situation

In the numerical controller 30, one of virtual control panels set using FIGS. 4, 5, and 6 is set as a default screen in advance. When a machining program is executed, the virtual control panel set as the default screen is displayed on the display screen 27 of the display device 22.

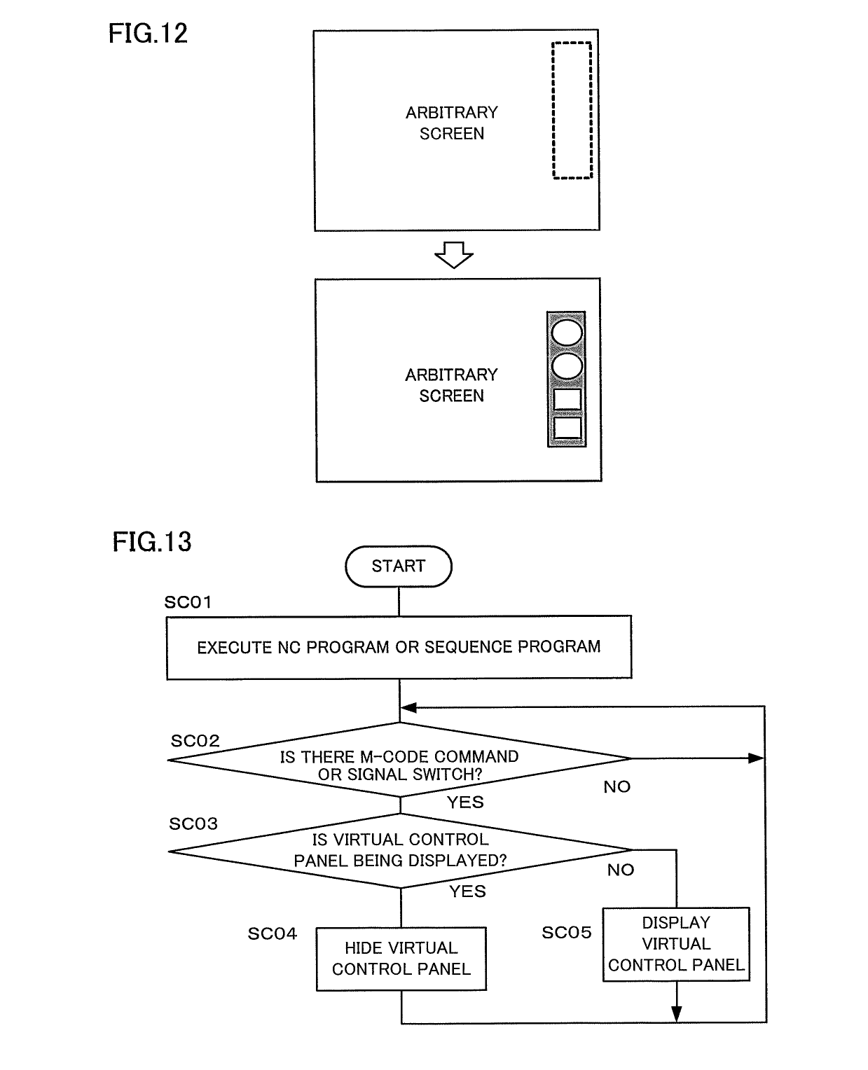

However, in some cases, it may be desirable to automatically select and display a virtual control panel in which only necessary buttons and lamps suited to a machining situation in which a workpiece is machined using a machine tool are set. In such a case, an M-code or a signal address associated with each virtual control panel is set. Each virtual control panel is switched between display and non-display by giving the associated M-code in a machining program (see FIGS. 11A and 12). Alternatively, each virtual control panel is switched between display and non-display by turning on the associated signal in a sequence program (see FIGS. 11B and 12). FIGS. 11A and 11B are views for explaining an example of a machining program (NC program) and an example of a sequence program which give instructions to hide and display the virtual control panel VCP1. FIG. 12 is a view for explaining non-display and display of the virtual control panel VCP1 according to an M-code command.

In FIG. 11A, reference numeral 60 denotes an M-code associated with the virtual control panel VCP1. When a block including the M-code 60 expressed as “M**” is executed at the time of machining a workpiece by the NC program O***, the virtual control panel VCP1 is switched from non-display to display according to the contents of the M-code command, as shown in FIG. 12. Note that ‘*’ represents an Arabic numeral.

In FIG. 11B, reference numeral 61 denotes a signal associated with the virtual control panel VCP1. As shown in FIG. 12, the virtual control panel VCP1 is switched from non-display to display according to the signal associated with the virtual control panel VCP1 in the sequence program as in FIG. 11B.

FIG. 13 is a flow chart showing a process to be executed by a virtual control panel display execution section. The process will be described below along with steps. Here, the function of monitoring a requirement for switching a virtual control panel between display and non-display (an M-code command or a change in signal) to determine whether to switch the virtual control panel from non-display to display or from display to non-display, and, when such switching is necessary, switching the virtual control panel between display and non-display is performed by “virtual control panel display execution section”. Monitoring of a signal is performed by a sequence program. The process of determining whether to display or hide a virtual control panel and draw or erase the virtual control panel on or from a screen is performed by application software on the NC controller.

[Step SC01] An NC program (or a sequence program) is executed.
[Step SC02] It is determined whether there is an M-code command (or a signal switch) in the running NC program (or the running sequence program). If there is an M-code command (or a signal switch) (YES), the processing proceeds to step SC03. On the other hand, if there is neither an M-code command nor a signal switch (NO), the processing waits for an M-code command (or a signal switch).
[Step SC03] It is determined whether a virtual control panel is being displayed. If the virtual control panel is being displayed (YES), the processing proceeds to step SC04. On the other hand, if the virtual control panel is not being displayed (NO), the processing proceeds to step SC05.
[Step SC04] The virtual control panel is hidden, and the processing returns to step SC02.
[Step SC05] The virtual control panel is displayed, and the processing returns to step SC02.

### (4) Input/output of Setup Data for Virtual Control Panel

Pieces of data which are set using the setup screens as shown in FIGS. 4, 5, and 6 may be output to a device external to the numerical controller 30. Alternatively, a virtual control panel may be set by loading pieces of data in an external device.

As has been described above, according to the embodiment of the present invention, a virtual control panel to be displayed on a screen is automatically selected as needed. This eliminates the need to display a virtual control panel across a screen and the need to select a target virtual control panel each time a button or a lamp needs to be operated or checked and improves workability. Also, only necessary buttons and lamps are displayed, which prevents erroneous operation and check and simplifies work. Additionally, a virtual control panel is displayed in a minimum necessary display space, which reduces an area where the virtual control panel overlaps with a different screen and improves workability. Moreover, the size and display position of a virtual control panel can be changed by an M-code command or a signal switch, and an easy-to-see, easy-to-use virtual control panel can be displayed according to an already displayed screen. This improves workability.

Furthermore, setup data for a virtual control panel can be input and output, which facilitates movement and copying of a virtual control panel to another machine tool.

What is claimed is:

1. A numerical controller comprising:
a display which displays a virtual control panel composed of an operation key for operating a machine and a lamp indicating operating information of a machine;
a virtual control panel definition information storage section in which a plurality of components of each of a plurality of the virtual control panels are defined and stored;
a virtual control panel association section which sets association of a command code to be given by an NC program with each of the virtual control panels that is composed of the defined components and whether to display or hide the virtual control panel; and
a virtual control panel display execution section which, when the NC program is executed, and one of the command codes set in the virtual control panel association section is read, displays or hides one of the virtual control panels that corresponds to the command code.

2. The numerical controller according to claim 1, further comprising:
a virtual control panel display attribute setting section which sets a command code to be given by the NC program for changing display attributes including size and display position of each of the virtual control panels; and
a virtual control panel attribute changing section which changes, when the NC program is executed and one of the command codes for changing display attributes is read, the size and display position of one of the virtual control panels that corresponds to the command code.

3. The numerical controller according to claim 1, further comprising a definition information input/output section which inputs and outputs virtual control panel definition information stored in the virtual control panel definition information storage section.

4. A numerical controller comprising:
a display which displays a virtual control panel composed of an operation key for operating a machine and a lamp indicating operating information of a machine;
a virtual control panel definition information storage section in which a plurality of components of each of a plurality of the virtual control panels are defined and stored;
a virtual control panel association section which sets association of a signal address to be used in a sequence program with each of the virtual control panels that is composed of the defined components and whether to display or hide the virtual control panel; and
a virtual control panel display execution section which, when the sequence program is executed, and one of the signal addresses set in the virtual control panel association section is output, displays or hides one of the virtual control panels that corresponds to the signal address.

5. The numerical controller according to claim 4, further comprising:
a virtual control panel display attribute setting section which sets a signal address to be used in the sequence program for changing display attributes including size and display position of each of the virtual control panels; and
a virtual control panel attribute changing section which changes, when the sequence program is executed and one of the signal addresses for changing display attributes is output, changes the size and display position of one of the virtual control panels that corresponds to the signal address.

6. The numerical controller according to claim 4, further comprising a definition information input/output section which inputs and outputs virtual control panel definition information stored in the virtual control panel definition information storage section.
